(19) United States
(12) Patent Application Publication
(10) Pub. No.: US 2013/0049985 A1
(43) Pub. Date: Feb. 28, 2013

(54) Device and system to alert vehicles and pedestrians of approaching emergency vehicles and emergency situations

(71) Applicants: Henry Eisenson, San Diego, CA (US); James M. Ross, Orange, CA (US)

(72) Inventors: Henry Eisenson, San Diego, CA (US); James M. Ross, Orange, CA (US)

(21) Appl. No.: 13/593,380

(22) Filed: Aug. 23, 2012

Related U.S. Application Data
(60) Provisional application No. 61/526,893, filed on Aug. 24, 2011.

(51) Int. Cl. G08G 1/0965

(52) U.S. Cl. 340/902

(57) ABSTRACT

A device and system to alert traffic and pedestrians of an approaching emergency vehicle or an emergency condition, comprised of a solar-charged battery that powers acoustic and optical detectors of approaching sirens and flashing lights or of appropriate transmitters, circuitry to validate the source as an emergency vehicle or authorized transmitter, and local strobe lights and noise emitters to alert vehicles and pedestrians.

### CROSS-REFERENCE TO RELATED APPLICATIONS

This application claims priority to U.S. Provisional Application No. 61/526,893, filed on Aug. 24, 2011, which is incorporated herein by reference in its entirety

### FIELD OF THE INVENTION

The present invention relates to the general fields of emergency vehicle operations and traffic safety.

### BACKGROUND OF THE INVENTION

Emergency vehicles, such as ambulances and police cars, use various combinations of flashing lights, sirens, horns and other optical alerts and noisemakers to signal traffic and pedestrians of their approach.

In virtually all jurisdictions, laws and regulations require that when a driver notices an approaching emergency vehicle, he must move his own vehicle to the side of the roadway to make space, allowing the emergency vehicle to safely pass.

However, when a vehicle is moving forward, the visual attention of the driver is usually focused upon the visual range in front of the vehicle, and the interior of a modern car is usually quietened with damping and sound isolation materials, so when filled with the sound of music, a speaking passenger, or a telephone conversation, the auditory attention of the driver is usually unaware of sound sources outside the vehicle.

Research has shown that despite sirens and flashing lights, most drivers fail to notice emergency vehicles behind them until they are closer than 100′. This problem is aggravated by cellphones, stereos, and the improved acoustic treatment of modern vehicles.

When the emergency vehicle and traffic are converging at right angles, as in cross streets, the emergency vehicle's flashing lights are not visible to the crossing traffic until the situation becomes urgent. This is particularly problematic when buildings mask visibility and absorb sound.

When an emergency vehicle is overtaking in daylight hours, studies have shown that emergency flashing lights are not seen at all unless a driver happens to glance at a rear view mirror.

The problems are most severe at intersections, where most accidents involving emergency vehicles occur. At intersections controlled by stop signs, most emergency vehicle drivers are forced to come to a stop to ensure safety. At intersections controlled by traffic lights, many emergency vehicles are equipped with electronic or infrared signalers enabling them to take control of traffic lights, expediting their passage through the intersection. However, a rapid change in the state of a traffic signal does not alone ensure the safety of such passage, due to impatience of drivers who may not otherwise notice the approaching emergency vehicle.

Statistics published by highway safety agencies show that existing emergency vehicle alerting methods do not capture the attention of many drivers, and the deficiency often creates accidents. The problem also jeopardizes pedestrians. Said deficiencies also create delays in the arrival of emergency vehicles where they are needed.

Failures to capture driver attention have been recognized, and attempts have been made to rectify the problem. Some emergency vehicles are equipped with an electro-mechanical vibration mechanism that transmits a rumbling through the street surface to surrounding cars, surpassing ordinary acoustic masking by music and conversation, and capturing the attention of a driver. Various combinations of high-intensity strobe lights have been used on emergency vehicles in an attempt to trigger recognition by drivers. Emergency vehicles have been fitted with infra-red or radio transmitters, and traffic lights are fitted with compatible receivers, enabling approaching vehicles to control traffic lights and more safely traverse intersections controlled by such lights.

Despite advances in siren, horn, rumbler, lighting, and remote traffic light control technologies, there are still many accidents involving emergency vehicles, there are still accidents between emergency vehicles and pedestrians, between ordinary vehicles that—while getting out of the way of an oncoming emergency vehicle—injure pedestrians, and there are still many instances in which emergency vehicles are delayed by traffic that does not have sufficient advance warning of their approach and therefore does not create space for their efficient passage, and such delays add time to the arrival of the emergency vehicle at its destination.

No device, system, or method has been discovered in the marketplace or in patent files that adequately addresses this deficiency. Statistics show that many accidents involve emergency vehicles, and studies show that they are not perceived by traffic until they become very close.

### OBJECTIVES OF THE PRESENT INVENTION

The primary objective of the present invention is to provide a useful and cost-effective system by which the approach of an emergency vehicle can be signaled to nearby vehicles and pedestrians well in advance of the arrival of the emergency vehicle itself.

The present invention is intended to detect approaching emergency vehicles with greater sensitivity than is possible in a closed and sound-insulated car with music playing, or in the presence of a competing conversation, and then trigger an alerting signal that is more likely to capture a driver's attention than events in the rear view mirror or inside the car.

The present invention is also intended to alert vehicles nearing an intersection when an emergency vehicle is approaching from an angle, and its flashing lights cannot be seen and its sirens or horns are not audible from the cross street.

The present invention is also intended to alert pedestrians, increasing the probability that they will remain on the sidewalk and stay safe until the emergency vehicle has passed.

The present invention is also intended to provide operators of emergency vehicles a new method for alerting drivers and pedestrians that an emergency vehicle is approaching.

The present invention is not intended to replace existing signaling systems or traffic control mechanisms, or to interrupt or change the light sequence of a traffic signal, or to change existing safe driving tactics, but to add a new capability to the interface between emergency vehicles and the vehicles and pedestrians in the environment through which such emergency vehicles must pass, simultaneously improving safety and speed of passage.

The ultimate objective of the present invention is to reduce accidents, and improve the availability of emergency services to emergency situations, and in both cases, to reduce injuries and fatalities.

### BRIEF SUMMARY OF THE PRESENT INVENTION

In the preferred embodiment, the present invention is comprised of a weathertight enclosure with a solar panel on an appropriate outer surface, so configured as to be easily mounted on trees, posts, corners of buildings, power poles, standards of street lights, or street signs, in a position in which the solar panel is most favorably exposed to the sun, and physically at a relatively low level so drivers are most likely to see it. The enclosure houses the following internal functions:
a. Detectors that sense acoustic signals and optical lights.
b. Filters that can discriminate between those signals and lights that emanate from an emergency vehicle and those which do not.
c. A digital signal processor or digital filter that can further qualify detected signals as those emitted by emergency vehicles.
d. An optical signaler, such as a strobe light or scrolling/flashing LED screen that can be seen by approaching vehicles.
e. An acoustic signaler, such as a piezoelectric siren or pulsing tone generator that can be heard by pedestrians.
f. A timer to limit the duration of the signaling and to control noise during nighttime hours.
g. A power storage means such as a rechargeable battery, kept charged by the aforementioned solar panel, and of sufficient capacity to meet the calculated requirements of the system with sufficient margin to permit operation even on repetitive bad weather days with minimal sunshine, with a power reserve consistent with the meteorology of the installation site.

Such devices deployed as a system, mounted along appropriate thoroughfares by vandalism-resistant means upon suitable locations such as building corners, signposts, streetlight standards, or even trees, at a vertical distance above street level determined to be within the visual range of typical approaching drivers. Each unit operates as follows:
a. The acoustic sensor detects a siren, and/or the optical sensor detects a flashing light, and
b. Filters plus digital signal processing matches the sound and/or the flashing light to that of an emergency vehicle, and
c. The strobe and/or acoustic signaler is/are turned ON, thus alerting vehicles within visual range and pedestrians with earshot, and
d. After the programmed operating interval, the internal timer turns the unit OFF and after a preset interval the device resets to a DETECT mode.

All of the electrical and mechanical components of the present invention are comprised of well-understood technologies, devices, and skills and therefore need not be discussed in detail. It is the assembly, juxtaposition, and interconnections of those known components, and the configuration of the result to accomplish the objectives described herein, that uniquely comprise the present invention.

The scope of the present invention includes all devices that combine sensor(s) to detect distant emergency vehicles with a local alerting means, whether the device detects acoustic, optical, infra-red, or radio signals from the approaching emergency vehicle, and whether the local alerting means is an audio or optical signal, and whether the device is electrified by a battery, rechargeable or primary, or by a tap of power from a street light or similar source.

### VARIATIONS UPON THE PRESENT INVENTION

Multiple such units can be combined into “networks”, in which units detect and repeat the alerting signal of nearby units. In such variations, the combination of such units becomes a system in which the alerting of distant but approaching emergency vehicles covers not only immediate, local points but areas.

When units of the present invention are combined into such a network, each is sensitized to the flashing of a similar unit within its detection range, thus enabling the alerting signal to be “re-transmitted” along a street, well in advance of an oncoming emergency vehicle and beyond the hearing range of its siren and beyond the visual range of its flashing lights. To prevent runaway feedback between units of the present invention, a microcontroller and timer in the control circuit will add a specified period to the previously detected flash interval as the distance from the original source, and presumably the emergency vehicle, increases. The delay will grow to become outside the preset periodicity detection of the unit within a set number of cycles.

By way of example, assume that in the intended area of operation, emergency vehicle strobe lights have a flash periodicity of 2 fps (two flashes per second), and units of the present invention are preset to detect flashes in the range of 1 fps to 4 fps (which allows for extreme Doppler). In a re-transmitting implementation of the present invention, a unit of the system will detect flashes within that specified range and trigger its own strobe, but the periodicity of the strobe will be increased by some percentage. If the periodicity of the initial emergency vehicle strobe were 2 fps, and the percentage of increase were programmed to be 25%, then the first repetition would be (1.25×2.0=) 2.5 fps. The second repetition would be (1.25×2.5=) 3.125 fps, and the third would be (1.25×3.125=) 3.906 fps. If the logic of the system were programmed to reject flashes with a periodicity exceeding 4 fps, then the retransmission process would be limited to the third unit of the present invention, preventing runaway retransmission of alerts but enhancing the alerting radius. These numbers are given as one example of a means for preventing runaway retransmission.

Other means can be used to embed identification within the strobe signal emitted by a unit of the present invention, and detected by other units. When a high-powered LED is used as the strobe light source, the rapid rise and fall times inherent to LED operation enable coding that is not visible to the human eye, but is detectable by simple optical detectors. Such coding can be implemented in a variation of the present invention. If a unit of the present invention is equipped with optical sensors facing two directions of traffic, and therefore can “see” flashes emitted by two lines of units of the present invention, the strobe signal that it generates can contain information describing the direction of the oncoming emergency vehicle. When another unit of the present invention detects a strobe signal with embedded direction data that is meaningful to traffic and pedestrians proximate to that location, it will repeat the alert. When the direction data suggests that the emergency is not significant to that location, the alert will not be repeated. Implementation of this variation of the presentation requires multiple optical detectors, simple programmable logic to control operation, and a gated LED strobe to permit transmission of data within the flashing strobe signal. The result of this variation is a network that alerts vehicles and pedestrians only when emergency vehicles are approaching, and not when they have passed.

Alternatives for the optical signaler may be motion-simulating LEDs, LCDs, or other light or visual simulating units including scrolling text units comprised of multiple LEDs which warn by both visual stimulation and word association.

The visual warning unit may have in addition to the acoustic and optical sensor, or as a replacement thereof, a receiver to detect radio signals from a transmitter operated from an emergency vehicle or other sources. Said emergency vehicle transmitter could have any of three operational modes.
1. Push to activate when button is pressed (transmit), via a normally-OFF switch.
2. Push to activate (transmit) and de-activate (cease transmission), via an ON/OFF switch.
3. A continuous directional transmission that activates the optical signaler as long as it is receiving a signal, thereby activating the alerting device well ahead of the emergency vehicle and deactivating it once the emergency vehicle has passed.

In some environments it will be beneficial to equip units of the present invention with detectors sensitive to the existing signals transmitted by emergency vehicles to control traffic lights. By this means, an emergency vehicle approaching an intersection that does have traffic lights would be able to not only change a light from red to green, etc., but also trigger flashing strobes near the intersection corners, on various vertical standards, and in other ways alert vehicles and pedestrians in the intersection that an emergency is in progress.

In some environments it will be beneficial to equip units of the present invention with detectors sensitive to transmitters carried by law enforcement officers and traffic control officials on the ground and not in vehicles, enabling them to use the present invention to notify approaching traffic of an emergency condition.

In some installations, solar power can be replaced by a local source of electrical current (street lighting, sign lighting, etc.). In such cases, the option exists to provide a battery backup so emergency situations in which area power is lost can benefit from the present invention until power is restored.

To avoid annoyances to residents along a street equipped with the present invention, the strobe output pattern can be masked or curtailed with a shutter or other limiting device such that it is mostly visible along the long axis of the street, and therefore more visible to vehicles and less visible to residential windows.

The audio input sensor, which detects acoustic energy, can be any sort of transducer that converts acoustic energy to electric energy, for further processing. The present invention includes all microphones, microphone arrays, directional horns, and passive acoustic filters.

The optical energy input sensor, which detects flashing lights of specific types, wavelengths, and periodicities, can be any of several sorts of photodetector. All convert optical energy to electrical energy for further processing. The present invention includes all light detectors, arrays thereof, directional lenses, and passive optical filters.

The intelligence of the present invention can be a simple passive filter or array of optical and acoustic filters, microcontrollers, digital signal processors, or programmable computers, with any level of complexity and capability required by the task of the deployment site and circumstances.

In all but the simplest expression of the present invention, the detection device, which is analog, will be followed by an analog-to-digital converter (ADC), permitting further processing of detected information in the digital domain.

A radio receiver and associated circuitry can be added to the basic unit, permitting remote control and reprogramming of various parameters of the unit.

These embellishments, variations, and additions are within the scope of the present invention.

### BRIEF DESCRIPTION OF THE SEVERAL VIEWS OF THE DRAWINGS

FIG. 1 depicts the present invention in block diagram form.

FIG. 2 shows the signal path leading to decisions by the logic of the present invention.

FIG. 3 shows deployment of the present invention and its effect in the environment.

### DETAILED DESCRIPTION OF THE INVENTION

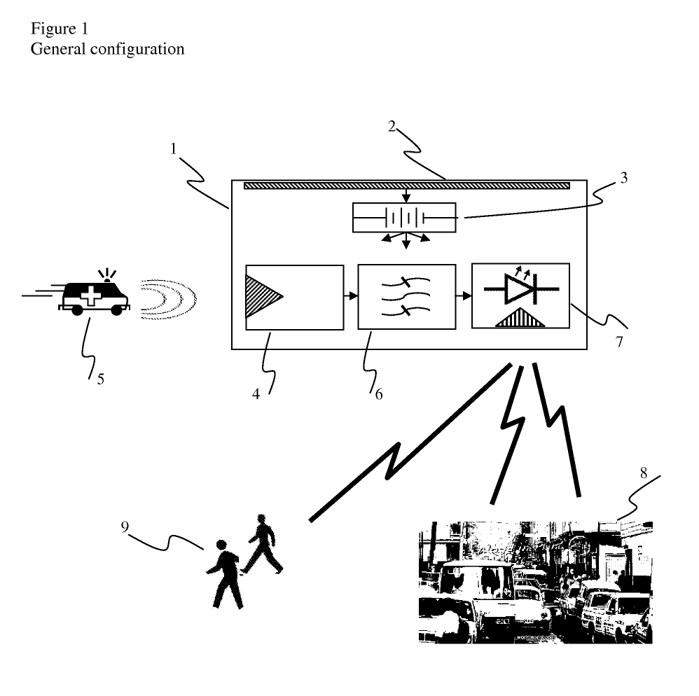

FIG. 1 illustrates the basic design of the present invention in block diagram form. A weatherproof outer enclosure 1 houses a solar panel 2 and a rechargeable battery 3 of sufficient capacity to power a detector 4, which can be acoustic, optical, or radio, or a combination thereof, that detects an oncoming emergency vehicle 5, and an intelligent filter 6, able to discriminate signals emitted from emergency vehicles, which triggers an alerting mechanism 7, in this case an LED strobe and piezoelectric siren module, which signals traffic 8 and pedestrians 9 of the approaching emergency vehicle 5.

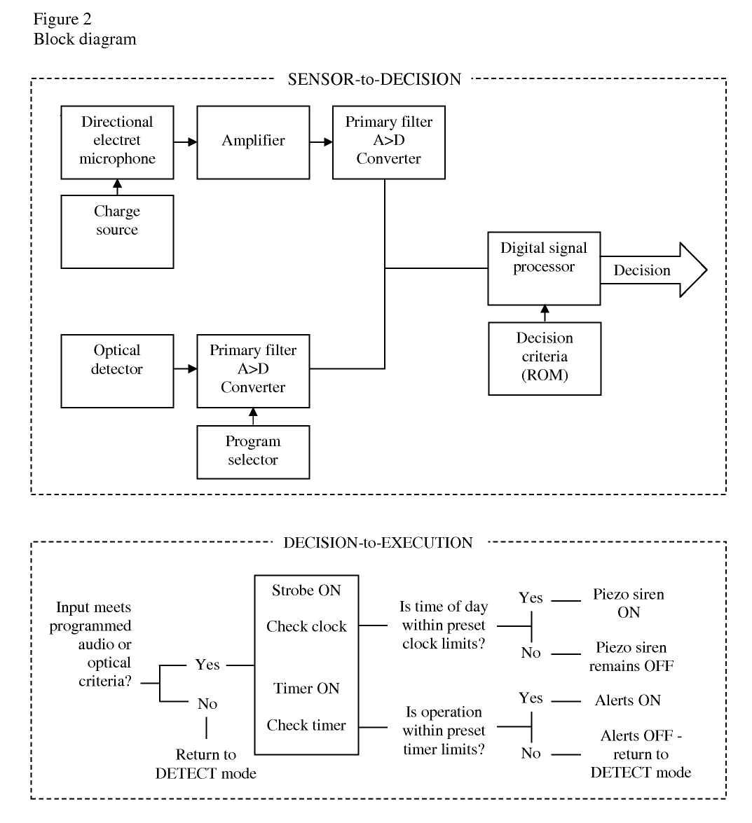

FIG. 2 shows one method (of many possible) in which a microphone's output can be amplified, filtered to remove energy that is outside the spectrum of sirens and horns, converted to the digital domain, then fed to a properly programmed digital signal processor for a decision as to whether the result is an approaching emergency vehicle. An optical sensor works similarly, examining the wavelength of and periodicity of light sources and making a decision based on pre-programmed information on local emergency vehicle standards. A real-time clock determines whether a siren turns on to alert pedestrians. A timer controls the period during which the system remains on.

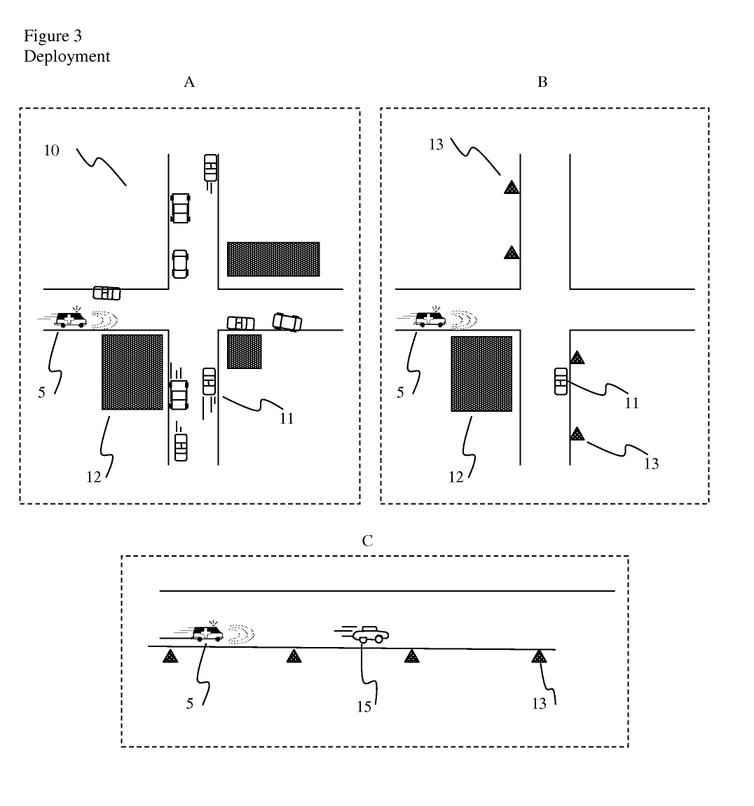

FIG. 3 illustrates deployment of the present invention and shows an emergency vehicle 5 approaching traffic. In A the emergency vehicle 5 is approaching an intersection 10 and is visible and audible to most drivers but not to the driver of vehicle 11 because of blocking by the building 12. B shows the deployment of the present invention 13 at appropriate elevated locations approaching the intersection, increasing the probability that the driver of vehicle 11 will be alerted despite the masking effect of building 12. In C the driver of vehicle 15 may be listening to passengers, cellphone, or music and not focusing on his rear-view mirror, so his detection of the emergency vehicle 5 approaching from that driver's rear is more probable if the present invention 13 detects said emergency vehicle 5 and provides alerting signals in his forward field of view.

We claim:

1. A system for alerting drivers of non-emergency vehicles that emergency vehicles are approaching from outside the visual or auditory range of said drivers by placing within their forward visual range at least one flashing alert, each containing a sensor able to detect optical signals emanating from said emergency vehicles and a microphone able to detect acoustic signals emanating from said emergency vehicles and logic able to discriminate between said detected optical and acoustic signals and ambient noises and lights from non-emergency sources, with said logic controlling a power switch that applies battery power to a flashing alert generator, with said battery connected to a charging source such as common grid power or a photovoltaic cell, so that detection by the device of an oncoming emergency vehicle triggers a local flashing signal, and if multiple said devices are installed on the corners of buildings or on lamp posts in the forward visual range of drivers, and one or more said devices detect an oncoming emergency vehicle, drivers are warned earlier than they would be if they depended solely upon the alerting mechanisms carried upon the emergency vehicles.

2. The device of claim 1 with the addition of an auditory alerting device such as a piezoelectric beeper triggered by the same logic that controls the flashing alert to drivers, thus providing an acoustic means for warning pedestrians in the immediate vicinity of the detection device, all in advance of the approaching emergency vehicle.

3. The device of claim 1 with adjustable optical shutters to ensure that the alerting flash is visible on the long axis of the street on which the device is installed, but not visible through the windows of residences and businesses on the sides of that street.

4. A network comprised of multiple iterations of the device described in claim 1 installed in an area such as an intersection of streets or along a route, with the visual alerts generated by said devices coded by internal logic in at least two optically discernible patterns, such that devices that detect an oncoming emergency vehicle will flash using Pattern One, and devices that flash as a result of detecting a Pattern One stimulus will also flash in accordance with Pattern Two, but no devices will flash as a result of detecting another device flashing in accordance with Pattern two, thus permitting any unit that detects an oncoming emergency vehicle to trigger repetitions of the alerting signal without causing an unlimited chain reaction beyond the area of the oncoming emergency vehicle.

5. The device of claim 1 with sensitivity to signals at wavelengths and frequencies sent by emergency vehicles to control traffic signals, enabling operators of such vehicles to control said devices from a distance using the same transmitter used to control traffic signals in the absence of sirens and flashing lights.

6. The device of claim 1 capable of being adjusted to recognize and respond to radio frequency, acoustic, and optical signals at any wavelength, periodicity, or coding transmitted by emergency vehicles or law enforcement officers or traffic control officials.
